(19) United States
(12) Patent Application Publication
(10) Pub. No.: US 2025/0216283 A1
(43) Pub. Date: Jul. 3, 2025

(54) Controlled Impact Test Wheel

(71) Applicant: Transportation Technology Center, Inc. d/b/a MxV Rail, Pueblo, CO (US)

(72) Inventors: Matthew Ward Witte, Tecumseh, MI (US); Shawn Alan Trevithick, Penrose, CO (US); Yuqing Zeng, Pueblo, CO (US); Michael Jacob Craft, Savage, MD (US)

(73) Assignee: Transportation Technology Center, Inc. d/b/a MxV Rail, Pueblo, CO (US)

(21) Appl. No.: 18/969,800

(22) Filed: Dec. 5, 2024

Related U.S. Application Data
(60) Provisional application No. 63/617,219, filed on Jan. 3, 2024.

(51) Int. Cl. G01L 27/00; B61K 9/10; B61L 23/04

(52) U.S. Cl. CPC G01L 27/002; B61K 9/10; B61L 23/042

(57) ABSTRACT

A controlled-impact test wheel provides repeatable vertical wheel impact load events to a rail during testing. The test wheel has a generally circular tread with at least one small recessed landing zone having a reduced rolling radius with bordering transition regions to exert a series of vertical impact loads on a rail as the wheel rolls along the rail during testing.

### RELATED APPLICATION

The present application is based on and claims priority to the Applicant's U.S. Provisional Patent Application 63/617,219, entitled “Controlled Impact Test Wheel,” filed on Jan. 3, 2024.

### BACKGROUND OF THE INVENTION

### Field of the Invention

The present invention relates generally to the field of testing equipment for railroads. More specifically, the present invention discloses a controlled-impact test wheel to provide repeatable vertical wheel impact load events to a rail during testing.

### Statement of the Problem

A wide variety of testing devices have been used in the past to test rails in service. Many testing systems require a vertical impact test load to be exerted on the rail that is detected by an on-track or on-vehicle testing device and used to identify faults or defects in the rail. Preferably, this test load should be repeatable and consistent as the testing device moves along the rail. Thus, a need exists for a device to generate a repeatable vertical wheel impact load with minimal complexity and expense.

### Solution to the Problem

The present invention provides a test wheel with a small portion of the tread having a reduced rolling radius designed to provide repeatable vertical wheel impact load events during testing. This is useful as a test standard for validating wheel impact load detectors and other on-track testing devices.

### SUMMARY OF THE INVENTION

This invention provides a controlled-impact test wheel to provide repeatable vertical wheel impact load events to a rail during testing. The test wheel has a generally circular tread with at least one small recessed landing zone having a reduced rolling radius with bordering transition regions to exert a series of vertical impact loads on a rail as the wheel rolls along the rail during testing.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a axonometric view of the test wheel 20.

FIG. 2 is a detail axonometric view of the test wheel 20 showing the transition regions 26, 28 and landing zone 24.

FIG. 3 is a graph showing an example of the wheel impact load exerted as the test wheel 20 rolls along a rail 10.

FIG. 4 is a diagram showing a test vehicle 30 with a test wheel 20 moving along a rail 10.

### DETAILED DESCRIPTION OF THE INVENTION

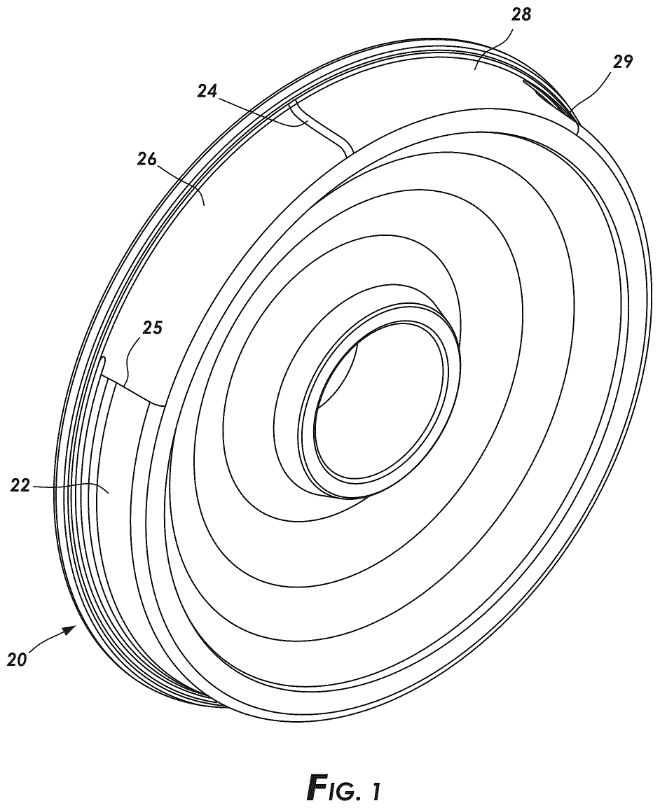

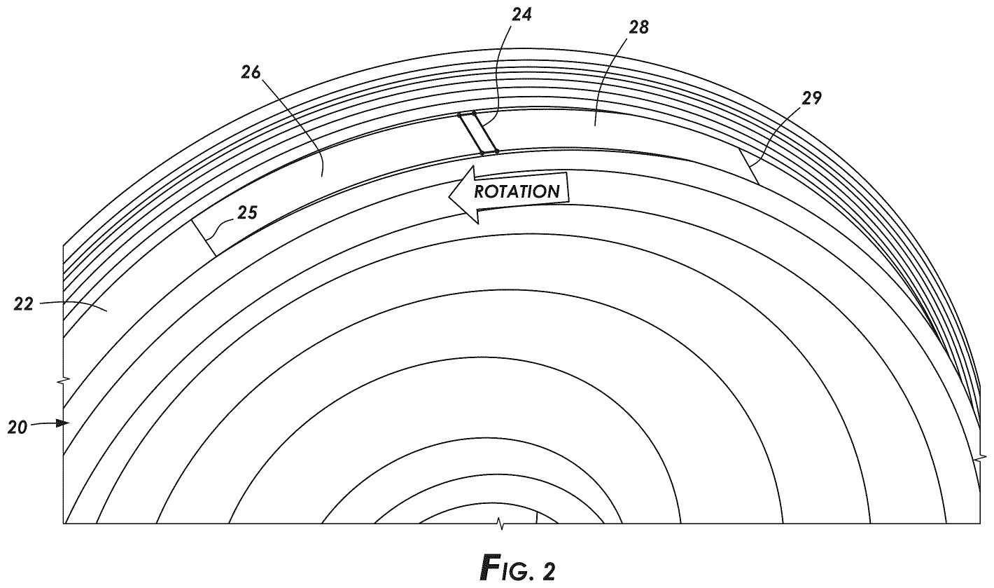

One embodiment of the present test wheel 20 is illustrated in FIG. 1. The test wheel 20 has the same general configuration as a conventional railway wheel with a large circumferential portion of the wheel 20 having a conventional tread 22 with a substantially constant radius. But, at least one small recessed circumferential region of the wheel 20 has a reduced rolling radius to define an engineered flat spot or landing zone 24, as shown in FIGS. 1 and 2. Preferably, the landing zone 24 is substantially flat (i.e., a chord of the wheel 20), or it can merely have a reduced radius of curvature relative to the remainder of the circumference of the wheel 20. This landing zone 24 is bordered by transition regions 26, 28 on either side.

Preferably, the lateral cross-sectional profiles of the treads of the landing zone 24 and transition regions (i.e., the tread profile perpendicular to the axis of the rail 10) remain substantially constant throughout these transitions, and consistent with the conventional AAR tread profile for a railway wheel. For example, a contour can be machined into the surface of a railway wheel 20 to produce a gradual change in the rolling radius while maintaining the tread profile. Preferably, the contour is symmetrical and circumferentially aligned across both wheels on the axle so that the varying rolling radius is the same on both wheels. The overall maximum depth of the contour is determined by the equivalent radius reduction of the landing zone 24 defined as a chord of depth.

In other words, the test wheel 20 can be viewed as having a conventional first region 22 with a tread extending around a portion of the circumference of the wheel 20. This conventional first region 22 has a substantially constant rolling radius and opposing first and second ends. The landing zone 24 has a tread with a reduced rolling radius between opposing first and second ends. The ramp-in transition region 26 has a tread extending from the first end 25 of the first region 22 to the first end of the landing zone 24. The ramp-out transition region 28 has a tread extending from the second end of the landing zone 24 to the second end 29 of the first region 22.

The landing zone 24 and transition regions 26, 28 define a continuous tread contour causing the wheel to exert repeated controlled vertical impact loads on the rail 10 at intervals as the test wheel 20 rolls along the rail 10 at a predetermined speed during testing. For example, the treads of the transition regions 26, 28 can be substantially linear ramps. The ramp-in and ramp-out rate of change of the radius in the transition regions 26, 28 can be selected to account for the desired critical speed of the wheel 20. This rate of change of the radius can be determined based on the freefall time from rest of the wheelset according to the distance traversed by the wheelset traveling forward at a predetermined speed. Preferably, the landing zone 24 is approximately tangent to the curve defined by the transition radii. In addition, the test vehicle 30 has a predetermined weight to produce a desired impact load on the rails 10. The resulting tread profile provides controlled unloading, impact and reloading of the vertical load path with a contour that is smooth, without abrupt change, and capable of holding shape without severe plastic deformation during a series of test runs.

There could be more than one landing zone 24 around the circumference of the wheel 20. For testing and simulating polygonal wheels (where flat spots develop at regular intervals around the tread circumference), a plurality of landing zones could be useful to create higher order wheel defects. The embodiment of the present invention discussed above is first order, with one defect per revolution of the wheel 20. Higher orders would include a plurality of landing zones with accompanying transition zones per indention spaced at predetermined intervals around the circumference of the wheel 20 to produce a corresponding plurality of impacts per revolution of the wheel 20.

The test wheel 20 is intended primarily as a component in a system to validate wheel impact load detectors for indicating wheelset removal. The engineered wheel defect provides a means to control multiple variables in the test environment during validation of on-board and in-track force measurement instruments. In this field of use, the present methodology is implemented by equipping a railway test vehicle 30 with test wheels 20, as discussed above. Preferably, the test wheel 20 is implemented as a component in a conventional railroad wheelset supporting a railway test vehicle 30. The rail 10 and/or test vehicle 30 are equipped with force measurement instruments 40, 45. The test vehicle 30 is then rolled along the rail 10 at a predetermined speed to produce repeated impacts on the rail 10 and the resulting loads are measured and stored for analysis.

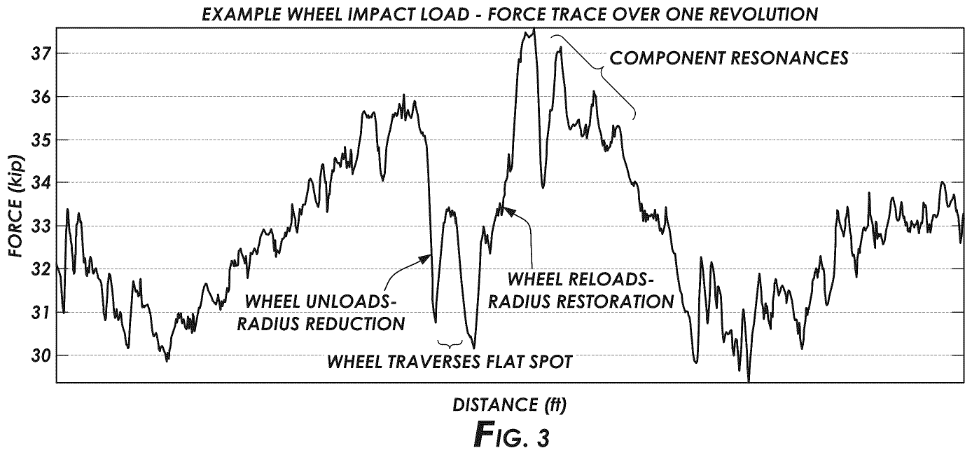

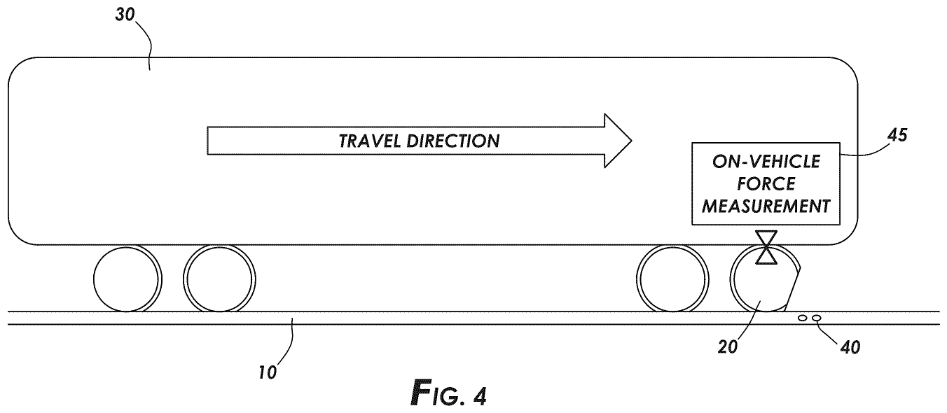

In-track and on-vehicle force measurement instruments 40, 45 are shown in FIG. 4. For example, strain gauges attached to the rail 10 can be employed to measure the resulting load exerted on the rail 10 as the test vehicle 30 moves along the rail 10, as shown in FIG. 3. Similarly, measurement instruments 45 carried on the test vehicle 30 can be used to measure the force or acceleration experienced by the test vehicle 30. The resulting loads measured by the measurement instruments 40, 45 based on the railway test vehicle 30 can be used for calibration to enable the measurement instruments 40, 45 to measure unknown loads in the field.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

We claim:

1. A railway test wheel for exerting a controlled impact load on a railway rail, said wheel comprising:
a first region having a tread extending around a portion of the circumference of the wheel with first and second ends and a substantially constant rolling radius;
a landing zone having a tread with a reduced rolling radius extending along a portion of the circumference of the wheel between the ends of the first region;
a ramp-in transition region with a tread extending from the first end of the first region to the landing zone; and
a ramp-out transition region with a tread extending from the landing zone to the second end of the first region;
wherein the treads of the first region, landing zone and transition regions define a tread contour causing the wheel to deliver a predetermined impact load to the rail as the wheel rolls along the rail at a predetermined speed.

2. The railway test wheel of claim 1 wherein the tread of the landing zone is a chord of the wheel.

3. The railway test wheel of claim 1 wherein the tread of the ramp-in transition region is a substantially linear ramp.

4. The railway test wheel of claim 1 wherein the tread of the ramp-out transition region is a substantially linear ramp.

5. The railway test wheel of claim 1 wherein the lateral cross-sectional profiles of the treads of the first region, landing zone and transition regions are substantially constant.

6. The railway test wheel of claim 1 wherein the wheel is a component in a wheelset supporting a railway test vehicle moving along a rail at a predetermined speed, and wherein the reduced radius of the landing zone is selected based on the freefall time of the wheelset.

7. The railway test wheel of claim 1 further comprising a plurality of landing zones and transition regions spaced at predetermined intervals around the circumference of the wheel.

8. A railway test wheel for exerting a controlled impact load on a railway rail, said wheel comprising:
a first region having a tread extending around a portion of the circumference of the wheel with first and second ends and a substantially constant rolling radius;
a landing zone having a tread extending along a portion of the circumference of the wheel between the ends of the first region, said landing zone having opposing first and second ends and a reduced rolling radius;
a ramp-in transition region with a tread extending from the first end of the first region to the first end of the landing zone; and
a ramp-out transition region with a tread extending from the second end of the landing zone to the second end of the first region;
wherein the treads of the first region, landing zone and transition regions define a continuous tread contour causing the wheel to deliver a predetermined impact load to the rail as the wheel rolls along the rail at a predetermined speed.

9. The railway test wheel of claim 8 wherein the tread of the landing zone is a chord of the wheel.

10. The railway test wheel of claim 8 wherein the tread of the ramp-in transition region is a substantially linear ramp.

11. The railway test wheel of claim 8 wherein the tread of the ramp-out transition region is a substantially linear ramp.

12. The railway test wheel of claim 8 wherein the lateral cross-sectional profiles of the treads of the first region, landing zone and transition regions are substantially constant.

13. The railway test wheel of claim 8 wherein the wheel is a component in a wheelset supporting a railway test vehicle moving along a rail at a predetermined speed, and wherein the reduced radius of the landing zone is selected based on the freefall time of the wheelset.

14. The railway test wheel of claim 8 further comprising a plurality of landing zones and transition regions spaced at predetermined intervals around the circumference of the wheel.

15. A method for exerting a repeated predetermined impact load to a railway rail to calibrate a force measurement instrument:
providing a railway test vehicle with a wheel having:
(a) a first region having a tread with first and second ends and a substantially constant rolling radius extending along a portion of the circumference of the wheel;
(b) a landing zone having a tread with a reduced rolling radius extending along a portion of the circumference of the wheel between the ends of the first region;
(c) a ramp-in transition region with a tread extending from the first end of the first region to the landing zone; and
(d) a ramp-out transition region with a tread extending from the landing zone to the second end of the first region;
rolling the railway test vehicle and wheel along a rail at a predetermined speed to produce repeated predetermined impact loads on the rail;
measuring the resulting loads on the rail using a force measurement instrument; and
calibrating the force measurement instrument to measure unknown loads based on the measured loads resulting from the railway test vehicle.

16. The method of claim 15 wherein the tread of the landing zone is a chord of the wheel.

17. The method of claim 15 wherein the force measurement instrument is on board the railway test vehicle.

18. The method of claim 15 wherein the force measurement instrument is coupled to the rail.

19. The method of claim 15 wherein the wheel is a component in a wheelset supporting the railway test vehicle, and wherein the reduced radius of the landing zone is selected based on the freefall time of the wheelset as the railway test vehicle and wheel move along the rail.

20. The method of claim 15 further comprising a plurality of landing zones and transition regions spaced at predetermined intervals around the circumference of the wheel.
